(19) United States
(12) Patent Application Publication
(10) Pub. No.: US 2015/0350076 A1
(43) Pub. Date: Dec. 3, 2015

(54) RAM, NETWORK PROCESSING SYSTEM AND TABLE LOOKUP METHOD FOR RAM

(71) Applicant: ZTE CORPORATION, Shenzhen, Guangdong (CN)

(72) Inventor: Haiming Jiang, Shenzhen, Guangdong Province (CN)

(21) Appl. No.: 14/653,506

(22) PCT Filed: Dec. 12, 2013
(86) PCT No.: PCT/CN2013/089238

§ 371 Date: Jun. 18, 2015

(30) Foreign Application Priority Data
Dec. 18, 2012 (CN) 201210549857.X

(51) Int. Cl. H04L 12/741; H04L 12/24

(52) U.S. Cl. CPC H04L 45/745; H04L 41/5054

(57) ABSTRACT

The disclosure provides an RAM, a network processing system and a table lookup method for the RAM. The RAM is divided into at least two virtual memory libraries, a same service table is stored in the at least two virtual memory libraries, and a proper virtual memory library is determined through the computation of a network memory to be accessed, so that the table lookup speed of the RAM is improved, the access traffic pressure is effectively reduced for the RAM, and the network forwarding performance is improved. Moreover, a same service table can be stored in the virtual memory libraries of the RAM, the table lookup speed of the RAM is increased maximally, and the network processor can compute the virtual memory library address information through hash computation.

### TECHNICAL FIELD

The disclosure relates to the technical field of communications, and in particular to a Random Access Memory (RAM), a network processing system and a table lookup method for the RAM.

### BACKGROUND

At present, with the astonishingly rapid development of the network, the increase of network traffic and the emergence of a new service, network equipment are required to have a high speed capability and a flexible processing capability. A network processor, with a high-speed processing capability and a flexible programmability, has become an effective solution for data processing in the existing network.

However, the forwarding speed of the network processor is increasing at an amazing speed now, and the forwarding speed of the existing mainstream network processor has reached 100 bps (in packet speed of 150 Mpps). Obviously, the increase speed of an RAM interface bandwidth cannot keep up with the increase of the forwarding speed of the network processor, therefore, how to improve the lookup speed for the RAM is a problem to be solved.

### SUMMARY

An embodiment of the disclosure provides an RAM, a network processing system and a table lookup method for the RAM, so as to solve the problem of low table lookup efficiency of the RAM.

The technical solution adopted by the embodiment of the disclosure is as follows:

A table lookup method for the RAM includes:

a network processor receives a service table access message from-each physical interface respectively;

the network processor parses the service table access message to acquire identifying information of a service table to be accessed by the service table access message;

a virtual memory library address is allocated to the service table access message according to the identifying information of the service table, wherein the virtual memory library address is an address of a virtual memory library which is in at least two virtual memory libraries divided by the RAM and contains the service table to be accessed, wherein a same service table is stored in at least two of the at least two virtual memory libraries of the RAM; and

a corresponding virtual memory library is searched according to the virtual memory library address for the corresponding service table.

Preferably, allocating the virtual memory library address may include: the network processor searches a virtual memory library which contains the service table to be accessed according to the identifying information of the service table carried in the service table access message, and selects the virtual memory library which has the lowest traffic to generate the virtual memory library address.

Preferably, in the at least two virtual memory libraries of the RAM, a same service table is stored in each of the at least two virtual memory libraries.

Preferably, allocating the virtual memory library address may include: the network processor determines the virtual memory library address corresponding to the service table access message through hash computation according to the identifying information of the service table carried in the service table access message.

Preferably, after the virtual memory library address corresponding to the service table access message is acquired, the method may further include: a table lookup key value is constructed according to the acquired virtual memory library address, and the corresponding service table is searched for in a corresponding virtual memory library according to the table lookup key value.

Preferably, the RAM includes one of a Static Random Access Memory (SRAM), a Ternary Content Addressable Memory (TCAM) and a Synchronous Dynamic Random Access Memory SDRAM.

An embodiment of the disclosure further provides an RAM, which includes at least two virtual memory libraries, wherein a same service table is stored in at least two of the at least two virtual memory libraries.

Preferably, in the at least two virtual memory libraries of the RAM, a same service table is stored in each of the at least two virtual memory libraries.

An embodiment of the disclosure further provides a network processing system, including a network processor and an RAM.

The network processor includes a receiving component, a parsing component, an allocation component, a lookup component and a processing component, wherein

the receiving component is configured to receive a service table access message from each physical interface respectively;

the parsing component is configured to parse the service table access message received by the receiving component to acquire the identifying information of a service table to be accessed by the service table access message;

the allocation component is configured to allocate a virtual memory library address for the service table access message according to the identifying information of the service table, wherein the virtual memory library corresponding to the virtual memory library address contains the service table to be accessed;

the lookup component is configured to look up the service table in a corresponding virtual memory library in the RAM according to the acquired virtual memory library address and forward a returned lookup result to the processing component; and

the processing component is configured to carry out the corresponding service processing according to the returned lookup result.

The RAM includes at least two virtual memory libraries, and a same service table is stored in at least two of the at least two virtual memory libraries of the RAM.

Preferably, the allocation component may further include: a selecting element which is configured to look up at least one virtual memory library which contains the service table to be accessed according to the identifying information of the service table carried in the service table access message and select the virtual memory library which has the lowest traffic to generate the corresponding memory address.

Preferably, the allocation component may further include a hash computing element which is configured to determine the virtual memory library address corresponding to the service table access message through hash computation according to the identifying information of the service table carried in the service table access message when a same service table is stored in all the virtual memory libraries in the RAM.

Preferably, the RAM is characterized by further including a constructing component which is configured to construct a table lookup key value according to the acquired virtual memory library address after the allocation component acquires the virtual memory library address corresponding to the service table access message; and the RAM looks up the corresponding service table in the corresponding virtual memory library according to the key value.

Preferably, the RAM includes one of an SRAM, a TCAM and an SDRAM.

The embodiments of the disclosure have the following beneficial effects: an RAM, a network processing system and a table lookup method for the RAM are provided; the RAM is divided into at least two virtual memory libraries, a same service table is stored in the at least two virtual memory libraries, and a proper virtual memory library is determined through the computation of a network memory to be accessed, so that the table lookup speed of the RAM is improved, the access traffic pressure is effectively reduced for the RAM, and the network forwarding performance is improved.

Moreover, a same service table can be stored in the virtual memory libraries of the RAM, the table lookup speed of the RAM is increased maximally, and the network processor can compute the virtual memory library address information through hash computation, so that the computation process is more simple and convenient, a proper virtual memory library can be found more effectively, and the table lookup efficiency and the network forwarding performance are further improved.

### BRIEF DESCRIPTION OF THE DRAWINGS

FIG. 1 is a diagram showing a structure of an SDRAM in an embodiment of the disclosure;

FIG. 2 is a diagram showing a structure of a network processor in an embodiment of the disclosure;

FIG. 3 is a diagram showing a structure of a network processor in another embodiment of the disclosure; and

FIG. 4 is a flowchart of a table lookup method for an RAM in an embodiment of the disclosure.

### DETAILED DESCRIPTION OF THE EMBODIMENTS

In the embodiments of the disclosure, an RAM is divided into a plurality of virtual memory libraries, a same service table is stored in at least two of the plurality of virtual memory libraries. When a service table access message indicates to access a corresponding service table, a service processor carries out a corresponding computation according to the identifying information of the service table carried in the service table access message, so that a proper virtual memory library address is acquired for accessing the RAM by a network processor. The RAM in the embodiments of the disclosure may be various memory libraries, such as a Static Random Access Memory (SRAM), a Ternary-Content Addressable Memory (TCAM) and a Synchronous Dynamic Random Access Memory (SDRAM), and the table lookup efficiency of all the memory libraries may be improved by the table lookup method in the disclosure. To describe the technical solution and advantages of the disclosure more clearly, the disclosure is described below in combination with the accompanying drawings and specific embodiments in detail.

In the embodiment of the disclosure, the RAM may be various memory libraries, but the SDRAM, limited by own structure, has a relatively low table lookup speed; and the table lookup method provided by the embodiment of the disclosure may achieve a better effect when it is applied to the SDRAM. Therefore, the technical solution of the application is described with the SDRAM as an example in the embodiment.

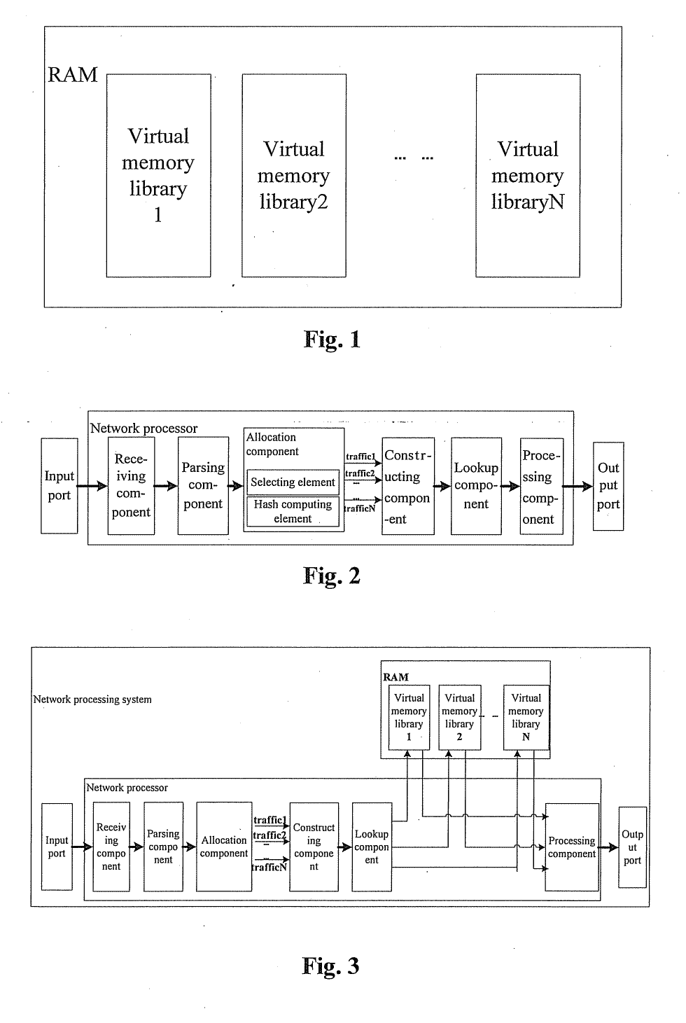

Please refer to FIG. 1, in one -embodiment, the SDRAM may be divided into at least two virtual memory libraries. For the table lookup speed of the whole SDRAM, preferably, the capacity of respective virtual memory libraries may be divided uniformly. In the embodiment, the SDRAM is divided into N virtual memory libraries. In order to improve the table lookup speed, a service table may be stored in two of the at least two virtual memory libraries respectively. Preferably, the same service table is stored in all the divided virtual memory libraries to improve the table lookup efficiency maximally. The number of the virtual memory libraries divided by the RAM may be greater than 1, preferably, the number N of the virtual memory libraries divided by the RAM may be F2/F1, where F1 is a frequency for searching the service table in each of the at least two virtual memory libraries, and F2 is a frequency, actually required by a service table, for searching the service table.

Please refer to FIGS. 2 and 3, one embodiment further provides a network processing system, which includes a network processor and an RAM. The network processor includes a receiving component, a parsing component, an allocation component, a lookup component and a processing component, wherein the receiving component is mainly configured to receive a service table access message from each physical interface; the parsing component is configured to parse the service table access message received by the receiving component and acquire identifying information of the service table accessed by the service table access message; the allocation component is configured to allocate a virtual memory library address for the service table access message according to the identifying information of the service table; the lookup component is configured to look up a service table in a corresponding virtual memory library in the RAM according to the acquired virtual memory library address and forward a returned lookup result to the processing component; and the processing component is configured to carry out a corresponding service processing according to the returned lookup result.

In one embodiment, the allocation component may further include: a selecting element which is mainly configured to query virtual memory libraries which contain the service table to be accessed according to the identifying information of the service table carried in the service table access message and select a virtual memory library which has the lowest traffic to generate the corresponding memory library address.

In one embodiment, another network processor is further provided, which includes a receiving component, a parsing component, an allocation component, a lookup component and a processing component; the functions of respective components are the same as those in the embodiment above, and the difference lies in that the allocation component here further includes: a hash computing element which is configured to determine the virtual memory library address corresponding to the service table access message through hash computation according to the identifying information of the service table carried in the service table access message when the same service table is stored in all the virtual memory libraries in the SDRAM.

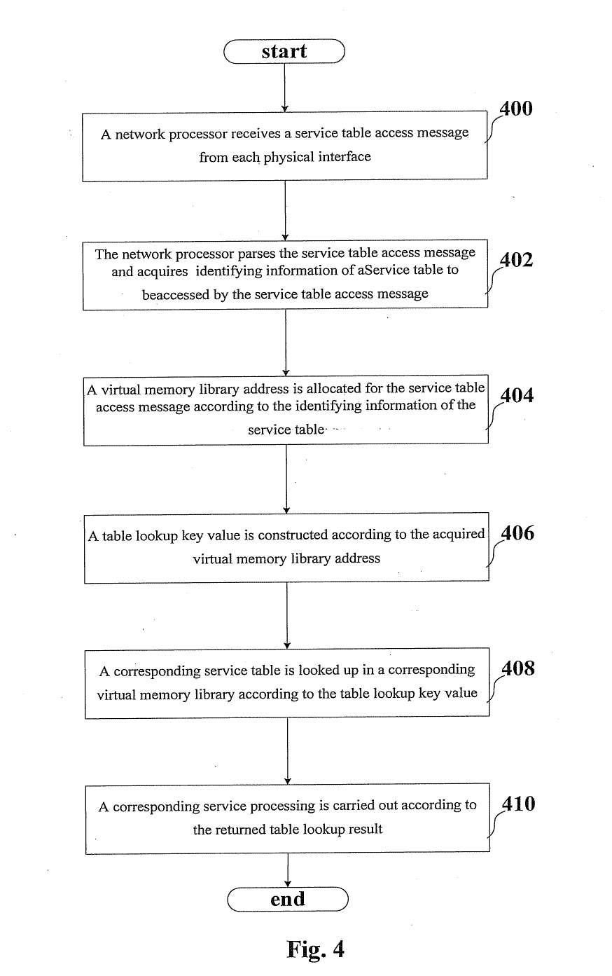

Please refer to FIG. 4, a table lookup method for an RAM in the application is described below in combination with the structure of the RAM and the function of respective components of the network processor in detail.

The table lookup method for the RAM in the embodiment includes the following steps S400-S410.

In step 400: A network processor receives a service table access message from each physical interface, and then Step 402 is executed.

In the step, the receiving component of the network processor is mainly responsible for receiving the service table access message from each physical interface.

In step 402: The network processor parses the service table access message and acquires identifying information of the service table carried in the service table access message, and then Step 404 is executed.

In the step, the parsing component is responsible for parsing the received service table access message and acquiring the identifying information of the service table carried in the service table access message, wherein the acquired identifying information of the service table is mainly MAC address information or IP address information and the like of the service table access message.

In step 404: A virtual memory library address is allocated for the service table access message according to the identifying information of the service table, and then Step 406 is executed.

In the step, when a same service table is not stored in all the virtual memory libraries in the RAM, a selecting element in an allocation component is responsible for querying a plurality virtual memory libraries containing a service table to be accessed according to the identifying information of the service table of the service table access message and selecting a virtual memory library having the lowest traffic to generate memory library address information. When a same service table is contained in all the virtual memory libraries in the RAM, a hash computing element in the allocation component determines a virtual memory library address corresponding to the service table access message through hash computation according to the identifying information of the service table of the service table access message.

In step 406: A table lookup key value is constructed according to the acquired virtual memory library address, and then Step 408 is executed.

In the step, the constructing component is responsible for constructing a corresponding table lookup key value according to the virtual memory library address acquired through the computation of the allocation component, namely, compiling the virtual memory library address into a corresponding table lookup key value.

In step 408: A corresponding service is looked up in a corresponding virtual memory library according to the table lookup key value, and then Step 410 is executed.

In the step, the lookup component is responsible for looking up a service table in a corresponding virtual memory library in the RAM according to a corresponding table lookup key value, and forwarding a returned table lookup result to the processing component.

Step 410: A corresponding service processing is carried out according to the returned table lookup result.

In the step, the processing component carries out a corresponding service processing according to the returned table lookup result.

The above are further descriptions of the disclosure in combination with the specific embodiments, and it can be understood that the specific embodiments of the disclosure are not only limited to these description. Various simple derivations or replacements can be made by those skilled in the art within the concept of the disclosure and pertain to the scope of protection of the disclosure.

1. A table lookup method for a Random Access Memory (RAM), comprising:
receiving, by a network processor, a service table access message from each physical interface;
the network processor parsing the service table access message to acquire identifying information of a service table to be accessed by the service table access message;
allocating a virtual memory library address for the service table access message according to the identifying information of the service table, wherein the virtual memory library address is an address of a virtual memory library which is in at least two virtual memory libraries divided by the RAM and contains the service table to be accessed, wherein a same service table is stored in at least two of the at least two virtual memory libraries of the RAM; and
accessing the virtual memory library corresponding to the virtual memory library address allocated to look up the corresponding service table.

2. The table lookup method for the RAM according to claim 1, wherein allocating the virtual memory library address comprises: the network processor looking up at least one virtual memory libraries which contains the service table to be accessed according to the identifying information of the service table carried in the service table access message, and selecting a virtual memory library which has the lowest traffic currently to generate the virtual memory library address.

3. The table lookup method for the RAM according to claim 1, wherein a same service table is stored in each of the at least two virtual memory libraries divided by the RAM.

4. The table lookup method for the RAM according to claim 3, wherein allocating the virtual memory library address comprises: determining, by the network processor, the virtual memory library address corresponding to the service table access message through hash computation according to the identifying information of the service table carried in the service table access message.

5. The table lookup method for the RAM according to claim 1, wherein after the virtual memory library address corresponding to the service table access message is acquired, the method further comprise: constructing a table lookup key value according to the acquired virtual memory library address, and looking up a corresponding service table in the corresponding virtual memory library according to the table lookup key value.

6. The table lookup method for the RAM according to claim 1, wherein the RAM comprises one of a Static Random Access Memory (SRAM), a Ternary Content Addressable Memory (TCAM) and a Synchronous Dynamic Random Access Memory (SDRAM).

7. A Random Access Memory (RAM), comprising at least two virtual memory libraries, wherein a same service table is stored in at least two of the at least two virtual memory libraries.

8. The RAM according to claim 7, wherein in the at least two virtual memory libraries of the RAM, a same service table is stored in each of the at least two virtual memory libraries.

9. A network processing system, comprising a network processor and a Random Access Memory (RAM), wherein
the network processor comprises a receiving component, a parsing component, an allocation component, a lookup component and a processing component;
the receiving component is configured to receive a service table access message from each physical interface;
the parsing component is configured to parse the service table access message received by the receiving component to acquire identifying information of a service table to be accessed by the service table access message;
the allocation component is configured to allocate a virtual memory library address for the service table access message according to the identifying information of the service table, the virtual memory library corresponding to the virtual memory library address containing the service table to be looked up;
the lookup component is configured to look up the service table in a corresponding virtual memory library in the RAM according to the acquired virtual memory library address and forward a returned lookup result to the processing component;
the processing component is configured to carry out the corresponding service processing according to the returned lookup result; and
the RAM comprises at least two virtual memory libraries, and a same service table is stored in at least two of the at least two virtual memory libraries of the RAM.

10. The network processing system according to claim 9, wherein the allocation component further comprise: a selecting element configured to search at least virtual memory library which contains the service table to be accessed according to the identifying information of the service table carried in the service table access message and select the virtual memory library which has the lowest traffic now to generate the corresponding virtual memory library address.

11. The network processing system according to claim 9, wherein the allocation component may further comprise a hash computing element configured to determine the virtual memory library address corresponding to the service table access message through hash computation according to the identifying information of the service table carried in the service table access message when a same service table is stored in all the virtual memory libraries in the RAM.

12. The network processing system according to claim 9, wherein the system further comprises a constructing component configured to construct a table lookup key value according to the acquired virtual memory library address after the allocation component acquires the virtual memory library address corresponding to the service table access message; and the RAM looks up the corresponding service table in the corresponding virtual memory library according to the table lookup key value.

13. The network processing system according to claim 9, wherein the RAM comprises one of a Static Random Access Memory (SRAM), a Ternary Content Addressable Memory (TCAM) and a Synchronous Dynamic Random Access Memory (SDRAM).

14. The table lookup method for the RAM according to claim 2, wherein after the virtual memory library address corresponding to the service table access message is acquired, the method further comprise: constructing a table lookup key value according to the acquired virtual memory library address, and looking up a corresponding service table in the corresponding virtual memory library according to the table lookup key value.

15. The table lookup method for the RAM according to claim 3, wherein after the virtual memory library address corresponding to the service table access message is acquired, the method further comprise: constructing a table lookup key value according to the acquired virtual memory library address, and looking up a corresponding service table in the corresponding virtual memory library according to the table lookup key value.

16. The table lookup method for the RAM according to claim 4, wherein after the virtual memory library address corresponding to the service table access message is acquired, the method further comprise: constructing a table lookup key value according to the acquired virtual memory library address, and looking up a corresponding service table in the corresponding virtual memory library according to the table lookup key value.

17. The table lookup method for the RAM according to claim 5, wherein after the virtual memory library address corresponding to the service table access message is acquired, the method further comprise: constructing a table lookup key value according to the acquired virtual memory library address, and looking up a corresponding service table in the corresponding virtual memory library according to the table lookup key value.

18. The network processing system according to claim 10, wherein the system further comprises a constructing component configured to construct a table lookup key value according to the acquired virtual memory library address after the allocation component acquires the virtual memory library address corresponding to the service table access message; and the RAM looks up the corresponding service table in the corresponding virtual memory library according to the table lookup key value.

19. The network processing system according to claim 11, wherein the system further comprises a constructing component configured to construct a table lookup key value according to the acquired virtual memory library address after the allocation component acquires the virtual memory library address corresponding to the service table access message; and the RAM looks up the corresponding service table in the corresponding virtual memory library according to the table lookup key value.

20. The network processing system according to claim 10, wherein the RAM comprises one of a Static Random Access Memory (SRAM), a Ternary Content Addressable Memory (TCAM) and a Synchronous Dynamic Random Access Memory (SDRAM).
